(19) United States
(12) Patent Application Publication
(10) Pub. No.: US 2026/0172663 A1
(43) Pub. Date: Jun. 18, 2026

(54) DIGITAL SELF-LEVELING PIPE INSPECTION CAMERA SYSTEMS AND METHODS WITH AUTOMATIC MAGNIFICATION

(71) Applicant: SeeScan, Inc., San Diego, CA (US)

(72) Inventors: Michael J. Martin, San Diego, CA (US); Alexander L. Warren, Escondido, CA (US); Mark S. Olsson, La Jolla, CA (US)

(21) Appl. No.: 19/403,144

(22) Filed: Nov. 27, 2025

Related U.S. Application Data
(60) Provisional application No. 63/726,858, filed on Dec. 2, 2024.

(51) Int. Cl. H04N 23/58; G06T 3/60; G06T 7/00; G06T 7/70; H04N 5/76; H04N 7/18; H04N 23/50; H04N 23/51; H04N 23/55; H04N 23/63; H04N 23/69; H04N 23/80

(52) U.S. Cl. CPC H04N 23/58; G06T 3/60; G06T 7/0002; G06T 7/70; H04N 5/76; H04N 7/183; H04N 23/51; H04N 23/55; H04N 23/555; H04N 23/631; H04N 23/69; H04N 23/80; G06T 2207/10016; G06T 2207/30244

(57) ABSTRACT

The application discloses various systems and methods using magnification to eliminate or substantially reduce empty spaces from letterboxing caused during self-leveling rotations of a digital self-leveling camera system. The display methods herein that utilize magnification to avoid the empty space associated letterboxing may provide an enhanced viewing experience for the end user.

### CROSS-REFERENCE TO RELATED APPLICATIONS

This application claims priority under 35 U.S.C. § 119(e) to U.S. Provisional Patent Application Ser. No. 63/726,858 entitled DIGITAL SELF-LEVELING PIPE INSPECTION CAMERA SYSTEMS AND METHODS WITH AUTOMATIC MAGNIFICATION, filed Dec. 2, 2024, the content of which is incorporated by reference herein in its entirety for all purposes.

### FIELD

This disclosure relates generally to methods and systems for improved display of digital self-leveling pipe inspection video images. More specifically, but not exclusively, the disclosure relates to methods and systems using automatic magnification in digital self-leveling pipe inspection cameras to eliminate or substantially reduce the areas of empty space associated with letterboxing during self-leveling.

### BACKGROUND

There are many applications where a video camera may be used to generate a video of a target or scene that may be viewed by a viewer in either real-time or in playback. In many such applications, it may be advantageous for the observed video to have an “upright” or earth normal orientation in order to facilitate ease in viewing, help visually orient the viewer, and may help prevent neck strain from having to cock their head to the side to bring an image closer to normal. For instance, in video pipe inspection systems, a camera may be affixed to one end of a resilient flexible push-cable such that the inspection camera may deployed into a pipe or other void that may otherwise be difficult to access for the purposes of inspection. The push-cable may distribute electrical power to the inspection camera as well as communicate a video signal with an electronic display device on the opposite end of the push-cable for the purpose of displaying and recording the video and, in some known systems, other in-pipe data gathered by the sensors in or near the camera. The inspection camera may twist and turn as it is moved through bends and turns in the pipe or other void. As the inspection camera twists and turns, the orientation of the frame of view captured by the inspection camera may likewise twist and turn causing a viewer to become disoriented to the upright, earth normal orientation.

Solutions to rectify the orientation of a video of a self-leveling camera system to being upright and earth normal are known in the art though such known solutions are less than ideal. In at least one solution known in the art, the camera may be configured to mechanically self-level. For instance, such inspection cameras may include a camera body that is mounted for free rotation within a camera housing and a leveling weight that is physically attached to the camera body. The center of mass of the weight is displaced from the axis of rotation of the camera body so that the camera body may be leveled via gravitational forces. However, this design does not lend itself to easy removal and/or repair of the video camera and associated electronics within the camera head. Likewise, such designs may lack the ruggedness desirable in an inspection camera commonly used in harsh environments such as one might find inside a corroded pipe.

Other solutions known in the art to rectify the orientation of a video to being upright and earth normal include digital self-leveling of the video images. In at least one known digital self-leveling solution, a digital flip and/or mirror is used both in LCD monitors as well as in some CCD cameras to rectify to approximate earth normal. The main advantages of the flip approach are low cost and preservation of the original aspect ratio of the video (typically 4:3). The primary disadvantage is the limited rotational resolution (only offering two positions, 0 degrees and 180 degrees of rotation). Likewise, other solutions may include utilizing a rectangular rotation at ninety-degree increments of video images via a processor (e.g., GPU or other processor) based on the output signal from one or more orientation sensors. Where such a solution slightly increases the rotational resolution (increasing from two positions of 0 degrees and 180 degrees of rotation to four positions of 0 degrees, 90 degrees, 180 degrees, and 270 degrees of rotation), such pipe inspection cameras and systems continue to suffer from sufficient rotational resolution and such ninety-degree jumps may be jarring to a viewer. As there is often a difference in horizontal to vertical image size measurements, the inspection images are often displayed using “letterboxing” of images which results in lobes, corners, or other areas of “empty space” to appear on the display to preserve the aspect ratio. It should be noted, that such “empty space,” in reality letterboxing may add black or other pixels in such areas to frame the field of view captured by the image sensors. The term “empty space” as used herein may refer to the lobes, corners, sides, or other areas created by letterboxing void of inspection imagery generally caused during rotations to correct orientations to upright and earth normal.

Further still, in some solutions known in the art of video pipe inspection, video images may be rotated continuously or at known small interval increments (e.g., less than ninety degrees) as performed via a processor (e.g., GPU or other processor) based on the output signal from the orientation sensor. Whereas such solutions are a vast improvement in terms of rotational resolution over other known solutions to digital rotate inspection images, the rectangular field of view may result in “letterboxing” or lobes, corners, or other areas of empty space not captured during rotations. Such empty space caused by letterboxing may be distracting to a user and wastes space on the display interface that may otherwise be used to view inspection images/video.

There are some known solutions in the art to attempt to improve upon letterboxing during self-leveling rotations. For instance, some solutions have attempted to crop, reduce video image sizes, or stretch of video images during such rotations generally result in reduced clarity on the viewer's behalf. For instance, reduced image size due to letterboxing or cropping of images, distortions from stretching images to fill blank spaces on the display, or the like. Likewise, other solutions may include blurring (e.g., Gaussian blur or the like) applied to the empty space during letterboxing. Such blurring techniques, though may improve the image transition during self-leveling rotations and thus lessening viewer confusion, still reduces the useful inspection image displayed.

Accordingly, there is a need in the art to address the above-described as well as other problems.

### SUMMARY

In accordance with one aspect of the present invention, a display method for use in digital self-leveling pipe inspection camera systems is disclosed. The method includes generating, via one or more image sensors disposed in an inspection camera, a video signal comprising a plurality of sequential inspection images representing the field of view captured by the camera and, via one or more orientation sensors disposed in the inspection camera, an orientation signal measuring the orientation of the inspection images relative to an upright, earth normal orientation. The method further includes receiving the video signal and orientation signal at a processing element having one or more graphics processing units (GPUs) or other processors and determining an orientation correction for the video signal describing rotations of the inspection images that reorients the images to most closely resemble an upright, earth normal orientation. The method further includes magnifying, based on the orientation correction, in on the field of view captured by the image sensor(s) to eliminate empty space caused by letterboxing. The method further includes outputting a corrected video signal that includes an upright, earth normal oriented and magnified video to eliminate empty space caused by letterboxing and displaying, on a display interface on one or more electronic display devices, the corrected upright and magnified video images from the corrected video signal.

In accordance with another aspect of the invention, an inspection system for digital self-leveling of inspection images that includes magnification to eliminate or substantially reduce empty space caused by letterboxing is disclosed. The inspection system includes an imaging element having one or more imaging sensors positioned behind one or more lenses and disposed in a housing in generating a video signal and an orientation element having one or more orientation sensors in generating an orientation signal describing the orientation of the inspection images relative to upright, earth normal orientation. The inspection system further includes a processing element having one or more processors receiving video signals and orientation signals from the inspection camera and outputting a corrected video signal having a corrected, upright, earth normal video that includes magnification, based on the rotation of the corrected, upright, earth normal video images, to eliminate or substantially reduce empty space caused by letterboxing and a display interface to display the corrected, upright, earth normal and magnified video images of the corrected video signal. The system further includes a memory element having one or more non-transitory memories for corrected video signal including magnified video images based on the rotation of the corrected, upright, earth normal video images to eliminate or substantially reduce empty space caused by letterboxing.

Various additional aspects, features, and functionality are further described below in conjunction with the appended Drawings.

### BRIEF DESCRIPTION OF THE DRAWINGS

The present application may be more fully appreciated in connection with the following detailed description taken in conjunction with the accompanying drawings, wherein:

FIG. 1A is an illustration of an embodiment of an inspection system in keeping with the present disclosure which may include magnification used in digital self-leveling to eliminate or substantially reduce empty space caused by letterboxing.

FIG. 1B is a diagram of an embodiment the inspection system from FIG. 1A.

FIG. 2 is an illustration showing orientation corrections and magnification to eliminate empty space caused by letterboxing and an example display interface.

FIG. 3 is a method for displaying inspection images from a digital self-leveling pipe inspection camera systems using magnification to eliminate empty space caused by letterboxing.

FIG. 4 is an illustration of another embodiment showing orientation corrections and greater than necessary magnification to eliminate empty space caused by letterboxing and an example display interface.

FIG. 5 is another method for displaying inspection images from a digital self-leveling pipe inspection camera systems using magnification greater than that needed to eliminate empty space caused by letterboxing.

FIG. 6 is an illustration showing orientation corrections and magnification to substantially reduce empty space caused by letterboxing and an example display interface.

FIG. 7 is another method for displaying inspection images from a digital self-leveling pipe inspection camera systems using magnification to substantially reduce empty space caused by letterboxing.

### DETAILED DESCRIPTION OF EMBODIMENTS

### Overview

In accordance with one aspect of the present invention, a display method for use in digital self-leveling pipe inspection camera systems. The method includes generating, via one or more image sensors disposed in an inspection camera, a video signal comprising a plurality of sequential inspection images representing the field of view captured by the camera and, via one or more orientation sensors disposed in the inspection camera, an orientation signal measuring the orientation of the inspection images relative to an upright, earth normal orientation. The method further includes receiving the video signal and orientation signal at a processing element having one or more graphics processing units (GPUs) or other processors and determining an orientation correction for the video signal describing rotations of the inspection images that reorients the images to most closely resemble an upright, earth normal orientation. The method further includes magnifying, based on the orientation correction, in on the field of view captured by the image sensor(s) to at least eliminate or substantially reduce empty space caused by letterboxing. The method further includes outputting a corrected video signal that includes an upright, earth normal oriented and magnified video to eliminate or substantially reduce empty space caused by letterboxing and displaying, on a display interface on one or more electronic display devices, the corrected upright and magnified video images from the corrected video signal. The corrected video signal having the upright, earth normal oriented and magnified video may be stored in one or more non-transitory memories. It should be noted that, in some embodiments, the method may be carried out and displayed in real-time or near real-time. In other embodiments, the method may be carried out in post-processing on one or more electronic display devices.

In some embodiments, the degree of magnification may exceed what is needed to eliminate the empty space caused by letterboxing. Likewise, in other embodiments, the degree of magnification may substantially reduce but may not fully eliminate empty space caused by letterboxing.

In some embodiments, additional information that may be non-rotating and non-magnified may be shown on a display interface during self-leveling of inspection video images independent of the inspection images of the corrected video signal.

In accordance with another aspect of the invention, an inspection system for digital self-leveling of inspection images that includes magnification to eliminate or substantially reduce empty space caused by letterboxing is disclosed. The inspection system includes an imaging element having one or more imaging sensors positioned behind one or more lenses and disposed in a housing in generating a video signal and an orientation element having one or more orientation sensors in generating an orientation signal describing the orientation of the inspection images relative to upright, earth normal orientation. The inspection system further includes a processing element (e.g., one or more GPUs or the like) having one or more processors receiving video signals and orientation signals from the inspection camera and outputting a corrected video signal having a corrected, upright, earth normal video that includes magnification, based on the rotation of the corrected, upright, earth normal video images, to eliminate or substantially reduce empty space caused by letterboxing and a display interface to display the corrected, upright, earth normal and magnified video images of the corrected video signal. The display interface may be or include a camera control unit (CCU), includes a smart phone, tablet or laptop computer, PC, or other remotely connected computing device. The system further includes a memory element having one or more non-transitory memories for corrected video signal including magnified video images based on the rotation of the corrected, upright, earth normal video images to eliminate or substantially reduce empty space caused by letterboxing.

Details of example devices, systems, and methods that may be used in or combined with the computer animation transition methods and system in the leveling of a video to an upright, earth normal orientation as used in pipe inspections embodiments described herein, are disclosed in co-assigned patents and patent applications including: U.S. Pat. No. 5,939,679, issued Aug. 17, 1999, entitled VIDEO PUSH CABLE; U.S. Pat. No. 6,545,704, issued Apr. 8, 1999, entitled VIDEO PIPE INSPECTION DISTANCE MEASURING SYSTEM; U.S. Pat. No. 6,831,679, issued Dec. 14, 2004, entitled VIDEO CAMERA HEAD WITH THERMAL FEEDBACK LIGHTING CONTROL; U.S. Pat. No. 6,862,945, issued Mar. 8, 2005, entitled CAMERA GUIDE FOR VIDEO PIPE INSPECTION SYSTEM; U.S. Pat. No. 6,958,767, issued Oct. 25, 2005, entitled VIDEO PIPE INSPECTION SYSTEM EMPLOYING NON-ROTATING CABLE STORAGE DRUM; U.S. patent application Ser. No. 12/704,808, filed Feb. 13, 2009, entitled PIPE INSPECTION SYSTEM WITH REPLACEABLE CABLE STORAGE DRUM; U.S. patent application Ser. No. 13/647,310, filed Feb. 13, 2009, entitled PIPE INSPECTION SYSTEM APPARATUS AND METHOD; U.S. patent application Ser. No. 13/346,668, filed Jan. 9, 2012, entitled PORTABLE CAMERA CONTROLLER PLATFORM FOR USE WITH PIPE INSPECTION SYSTEM; U.S. patent application Ser. No. 14/749,545, filed Jan. 30, 2012, entitled ADJUSTABLE VARIABLE RESOLUTION INSPECTION SYSTEMS AND METHODS; U.S. Pat. No. 8,289,385, issued Oct. 16, 2012, entitled PUSH-CABLE FOR PIPE INSPECTION SYSTEM; U.S. Pat. No. 8,395,661, issued Mar. 12, 2013, entitled PIPE INSPECTION SYSTEM WITH SELECTIVE IMAGE CAPTURE; U.S. patent application Ser. No. 13/826,112, filed Mar. 14, 2013, entitled SYSTEMS AND METHODS INVOLVING A SMART CABLE STORAGE DRUM AND NETWORK NODE FOR TRANSMISSION OF DATA; U.S. patent application Ser. No. 14/033,349, filed Sep. 20, 2013, entitled PIPE INSPECTION SYSTEM WITH SNAP-ON PIPE GUIDES; U.S. Pat. No. 8,540,429, issued Sep. 24, 2013, entitled SNAP ON PIPE GUIDE; U.S. Pat. No. 8,587,648, issued Nov. 19, 2013, entitled SELF-LEVELING CAMERA HEAD; U.S. patent application Ser. No. 14/136,104, filed Dec. 20, 2013, entitled ROTATING CONTACT ASSEMBLIES FOR SELF-LEVELING CAMERA HEADS; U.S. patent application Ser. No. 14/203,485, filed Mar. 10, 2014, entitled PIPE INSPECTION CABLE COUNTER AND OVERLAY MANAGEMENT SYSTEM; U.S. patent application Ser. No. 14/207,527, filed Mar. 12, 2014, entitled ROTATING CONTACT ASSEMBLIES FOR SELF-LEVELING CAMERA HEADS; U.S. patent application Ser. No. 14/216,358, filed Mar. 17, 2014, entitled SMART CABLE STORAGE DRUM AND NETWORK NODE SYSTEM AND METHODS; U.S. patent application Ser. No. 14/557,163, filed Dec. 1, 2014, entitled ASYMMETRIC DRAG FORCE BEARINGS; U.S. Pat. No. 8,908,027, issued Dec. 9, 2014, entitled ASYMMETRIC DRAG FORCE BEARING FOR USE WITH PUSH-CABLE STORAGE DRUM; U.S. Pat. No. 8,970,211, issued Mar. 3, 2015, entitled PIPE INSPECTION CABLE COUNTER AND OVERLAY MANAGEMENT SYSTEM; U.S. patent application Ser. No. 14/642,596, filed Mar. 9, 2015, entitled PIPE CLEARING CABLES AND APPARATUS; U.S. Pat. No. 8,984,698, issued Mar. 24, 2015, entitled LIGHT WEIGHT SEWER CABLE; U.S. patent application Ser. No. 14/746,590, filed Jun. 22, 2015, entitled THERMAL EXTRACTION ARCHITECTURES FOR CAMERA AND LIGHTING DEVICES; U.S. Pat. No. 9,066,446, issued Jun. 23, 2015, entitled THERMAL EXTRACTION ARCHITECTURE FOR CAMERA HEADS, INSPECTION SYSTEMS, AND OTHER DEVICES AND SYSTEMS; U.S. Pat. No. 9,080,992, issued Jul. 14, 2015, entitled ADJUSTABLE VARIABLE RESOLUTION INSPECTION SYSTEMS AND METHODS; U.S. Pat. No. 9,134,255, issued Sep. 15, 2015, entitled PIPE INSPECTION SYSTEM WITH SELECTIVE CAPTURE; U.S. patent application Ser. No. 14/935,878, filed Nov. 9, 2015, entitled INSPECTION CAMERA DEVICES AND METHODS WITH SELECTIVELY ILLUMINATED MULTISENSOR IMAGING; U.S. patent application Ser. No. 14/970,362, filed Dec. 15, 2014, entitled COAXIAL VIDEO PUSH-CABLES FOR USE IN INSPECTION SYSTEMS; U.S. Pat. No. 9,222,809, issued Dec. 29, 2015, entitled PORTABLE PIPE INSPECTION SYSTEMS AND APPARATUS; U.S. patent application Ser. No. 15/050,267, filed Feb. 22, 2016, entitled SELF-LEVELING CAMERA HEADS; U.S. Pat. No. 9,277,105, issued Mar. 1, 2016, entitled SELF-LEVELING CAMERA HEADS; U.S. patent application Ser. No. 15/264,355, filed Sep. 13, 2016, entitled HIGH BANDWIDTH VIDEO PUSH-CABLES FOR PIPE INSPECTION SYSTEMS; U.S. Pat. No. 9,448,376, issued Sep. 20, 2016, entitled HIGH BANDWIDTH PUSH-CABLES FOR VIDEO PIPE INSPECTION SYSTEMS; U.S. Pat. No. 9,468,954, issued Oct. 18, 2016, entitled PIPE INSPECTION SYSTEM WITH JETTER PUSH-CABLE; U.S. Pat. No. 9,477,147, issued Oct. 25, 2016, entitled SPRING ASSEMBLIES WITH VARIABLE FLEXIBILITY FOR USE WITH PUSH-CABLES AND PIPE INSPECTION SYSTEMS; U.S. patent application Ser. No. 15/369,693, filed Dec. 5, 2016, entitled CABLE STORAGE DRUM WITH MOVEABLE CCU DOCKING APPARATUS; U.S. Pat. No. 9,521,303, issued Dec. 13, 2016, entitled CABLE STORAGE DRUM MOVABLE CCU DOCKING APPARATUS; U.S. patent application Ser. No. 15/425,785, filed Feb. 6, 2017, entitled METHOD AND APPARATUS FOR HIGH-SPEED DATA TRANSFER EMPLOYING SELF-SYNCHRONIZING QUADRATURE AMPLITUDE MODULATION; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION; U.S. patent application Ser. No. 15/483,924, filed Apr. 10, 2017, entitled SYSTEMS AND METHODS FOR DATA TRANSFER USING SELF-SYNCHRONIZING QUADRATURE AMPLITUDE MODULATION; U.S. Pat. No. 9,625,602, issued Apr. 18, 2017, entitled SMART PERSONAL COMMUNICATION DEVICES AS USER INTERFACES; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION; U.S. patent application Ser. No. 15/590,964, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. patent application Ser. No. 15/670,845, filed Aug. 7, 2017, entitled HIGH FREQUENCY AC-POWERED DRAIN CLEANING AND INSPECTION APPARATUS AND METHODS; U.S. patent application Ser. No. 15/701,247, filed Sep. 11, 2017, entitled PIPE INSPECTION SYSTEMS WITH SELF-GROUNDING PORTABLE CAMERA CONTROLLERS; U.S. Pat. No. 9,769,366, issued Sep. 19, 2017, entitled ELF-GROUNDING TRANSMITTING PORTABLE CAMERA CONTROLLER FOR USE WITH PIPE INSPECTION SYSTEMS; U.S. Pat. No. 9,791,382, issued Oct. 17, 2017, entitled PIPE INSPECTION SYSTEM WITH JETTER PUSH-CABLE; U.S. patent application Ser. No. 15/728,410, filed Oct. 9, 2017, entitled PIPE INSPECTION SYSTEM WITH JETTER PUSH-CABLE; U.S. patent application Ser. No. 15/805,007, filed Nov. 6, 2017, entitled PIPE INSPECTION SYSTEM CAMERA HEADS; U.S. patent application Ser. No. 15/806,219, filed Nov. 7, 2017, entitled MULTI-CAMERA PIPE INSPECTION APPARATUS, SYSTEMS AND METHODS; U.S. patent application Ser. No. 15/811,264, filed Nov. 13, 2017, entitled SPRING ASSEMBLIES WITH VARIABLE FLEXIBILITY FOR USE WITH PUSH-CABLES AND PIPE INSPECTION SYSTEMS; U.S. Pat. No. 9,824,433, issued Nov. 21, 2017, entitled PIPE INSPECTION SYSTEM CAMERA HEADS; U.S. Pat. No. 9,829,783, issued Nov. 28, 2017, entitled SPRING ASSEMBLIES WITH VARIABLE FLEXIBILITY FOR USE WITH PUSH-CABLES AND PIPE INSPECTION SYSTEMS; U.S. Pat. No. 9,835,564, issued Dec. 5, 2017, entitled MULTI-CAMERA PIPE INSPECTION APPARATUS, SYSTEMS, AND METHODS; U.S. patent application Ser. No. 15/919,077, filed Mar. 27, 2018, entitled PORTABLE PIPE INSPECTION SYSTEMS AND METHODS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/922,703, filed Mar. 15, 2018, entitled SELF-LEVELING INSPECTION SYSTEMS AND METHODS; U.S. Pat. No. 9,924,139, issued Mar. 20, 2018, entitled PORTABLE PIPE INSPECTION SYSTEMS AND APPARATUS; U.S. Pat. No. 9,927,368, issued Mar. 27, 2018, entitled SELF-LEVELING INSPECTION SYSTEMS AND METHODS; U.S. Provisional Patent Application 62/686,589, filed Jun. 18, 2018, entitled MULTI-DIELECTRIC COAXIAL PUSH-CABLES; U.S. Provisional Patent Application 62/726,500, filed Sep. 4, 2018, entitled VIDEO PIPE INSPECTION SYSTEMS, DEVICES, AND METHODS INTEGRATED WITH NON-VIDEO DATA RECORDING AND COMMUNICATION FUNCTIONALITY; U.S. Provisional Patent Application 62/756,538, filed Nov. 6, 2018, entitled ROBUST AND LOW COST IMPEDANCE CONTROLLED SLIP RINGS; U.S. Provisional Patent Application 62/768,760, filed Nov. 16, 2018, entitled PIPE INSPECTION AND/OR MAPPING CAMERA HEADS, SYSTEMS, AND METHODS; U.S. Provisional Patent Application 62/794,863, filed Jan. 21, 2019, entitled HEAT EXTRACTION ARCHITECTURE FOR COMPACT VIDEO HEADS; U.S. Patent Application Ser. No. 16/443,789, filed Jun. 17, 2019, entitled MULTI-DIELECTRIC COAXIAL PUSH-CABLES AND ASSOCIATED APPARATUS; U.S. Pat. No. 10,356,360, issued Jul. 16, 2019, entitled HIGH BANDWIDTH VIDEO PUSH-CABLE FOR PIPE INSPECTION SYSTEMS; U.S. Pat. No. 10,359,368, issued Jul. 23, 2019, entitled PIPE INSPECTION SYSTEM WITH JETTER PUSH-CABLE; U.S. Pat. No. 10,379,436, issued Aug. 13, 2019, entitled SPRING ASSEMBLIES WITH VARIABLE FLEXIBILIY FOR USE WITH PUSH-CABLES AND PIPEINSPECTION SYSTEMS; U.S. Pat. No. 10,440,332, issued Oct. 8, 2019, entitled INSPECTION CAMERA DEVICES AND METHODS WITH SELECTIVELY ILLUMINATED MULTISENSOR IMAGINING; U.S. Pat. No. 10,527,402, issued Jan. 7, 2020, entitled PIPE INSPECTION SYSTEM CABLE COUNTER AND OVERLAY MANAGEMENT SYSTEM; U.S. Pat. No. 10,585,012, issued Mar. 10, 2020, entitled PORTABLE CAMERA CONTROLLER FOR USE WITH PIPE INSPECTION SYSTEMS; U.S. Pat. No. 10,613,034, issued Apr. 7, 2020, entitled SELF-LEVELING INSPECTION SYSTEMS AND METHODS; U.S. Pat. No. 10,715,703, issued Jul. 14, 2020, entitled SELF-LEVELING CAMERA HEADS; U.S. Pat. No. 10,761,233, issued Sep. 1, 2020, entitled SONDES AND METHODS FOR USE WITH BURIED LINE LOCATOR SYSTEMS; U.S. Pat. No. 10,764,541, issued Sep. 1, 2020, entitled COAXIAL VIDEO PUSH-CABLES FOR USE IN INSPECTION SYSTEMS; U.S. patent application Ser. No. 17/087,554, filed Nov. 2, 2020, entitled PORTABLE PIPE INSPECTION SYSTEMS AND METHODS; U.S. Pat. No. 10,834,364, issued Nov. 10, 2020, entitled PORTABLE PIPE INSPECTION SYSTEMS AND METHODS; U.S. Pat. No. 10,841,144, issued Nov. 17, 2020, entitled SYSTEM AND METHODS FOR DATA TRANSFER USING SELF-SYNCHRONIZING QUADRATURE AMPLITUFE MODULATION (QAM); U.S. Pat. No. 10,855,950, issued Dec. 1, 2020, entitled HIGH BANDWIDTH VIDEO PUSH-CABLES FOR PIPE INSPECTION SYSTEMS; U.S. Pat. No. 10,863,064, issued Dec. 8, 2020, entitled CABLE STORAGE DRUM WITH MOVEABLE CCU DOCKING APPARATUS; U.S. Pat. No. 10,907,690, issued Feb. 2, 2021, entitled PIPE INSPECTION SYSTEMS WITH ASSYMETRIC DRAG FORCE BEARINGS; U.S. Pat. No. 10,921,263, issued Feb. 16, 2021, entitled PIPE INSPECTION SYSTEM WITH JETTER PUSH-CABLE; U.S. patent application Ser. No. 17/182,113, filed Feb. 22, 2021, entitled VIDEO PIPE INSPECTION SYSTEMS; U.S. patent application Ser. No. 17/202,128, filed Mar. 15, 2021, entitled BORING INSPECTION SYSTEMS AND METHODS; U.S. Pat. No. 10,955,583, issued Mar. 23, 2021, entitled BORING INSPECTION SYSTEMS AND METHODS; U.S. Pat. No. 10,976,462, issued Apr. 13, 2021, entitled VIDEO INSPECTION SYSTEMS WITH PERSONAL COMMUNICATION DEVICE USER INTERFACES; U.S. Pat. No. 10,992,849, issued Apr. 27, 2021, entitled PIPE INSPECTION SYSTEMS WITH SELF-GROUNDING PORTABLE CAMERA CONTROLLERS; U.S. Pat. No. 11,016,381, issued May 25, 2021, entitled SPRING ASSEMBLIES WITH VARIABLE FLEXIBLE FOR USE WITH PUSH-CABLES AND PIPE INSPECTION SYSTEMS; U.S. patent application Ser. No. 17/397,940, filed Aug. 9, 2021, entitled INSPECTION SYSTEM PUSH-CABLE GUIDE APPARATUS; U.S. Pat. No. 11,088,890, issued Aug. 10, 2021, entitled VIDEO INSPECTION SYSTEMS AND METHODS USING SELF-SYNCHRONIZING QAM; U.S. Pat. No. 11,132,781, issued Sep. 28, 2021, entitled PIPE INSPECTION SYSTEM CAMERA HEADS; U.S. patent application Ser. No. 17/528,155, filed Nov. 16, 2021, entitled PORTABLE CAMERA CONTROLLER PLATFORM FPR USE WITH PIPE INSPECTION SYSTEMS; U.S. Pat. No. 11,178,317, issued Nov. 16, 2021, entitled HEAT EXTRACTION APPARATUS; U.S. patent application Ser. No. 17/528,956, filed Nov. 17, 2021, entitled VIDEO INSPECTION SYSTEM APPARATUS AND METHODS WITH RELAY MODULES AND CONNECTION PORTS; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/532,938, filed Nov. 22, 2021, entitled PIPE INSPECTION AND/OR MAPPING CAMERA HEADS, SYSTEMS, AND METHODS; U.S. Pat. No. 11,187,822, issued Nov. 30, 2021, entitled SONDE DEVICES INCLUDING SECTIONAL FERRITE CORE STRUCTURE; U.S. Pat. No. 11,187,971, issued Nov. 30, 2021, entitled ROTATING CONTACT ASSEMBLIES FOR SELF-LEVELING CAMERA HEADS; U.S. Pat. No. 11,199,510, issued Dec. 14, 2021, entitled PIPE INSPECTION AND CLEANING APPARATUS AND SYSTEMS; U.S. Pat. No. 11,209,115, issued Dec. 28, 2021, entitled PIPE INSPECTION AND/OR MAPPING CAMERA HEADS, SYSTEMS, AND METHODS; U.S. Pat. No. 11,209,334, issued Dec. 28, 2021, entitled PORTABLE CAMERA CONTROLLER PLATFORM FOR USE WITH PIPE INSPECTION SYSTEMS; U.S. Pat. No. 11,300,700, issued Apr. 12, 2022, entitled SYSTEM AND METHODS OF USING A SONDE DEVICE WITH A SECTIONAL FERRITE CORE STRUCTURE; U.S. patent application Ser. No. 17/868,709, filed Jul. 19, 2022, entitled INSPECTION CAMERA DEVICES AND METHODS; U.S. patent application Ser. No. 17/815,387, filed Jul. 27, 2022, entitled INWARD SLOPED DRUM FACE FOR PIPE INSPECTION CAMERA SYSTEM; U.S. Pat. No. 11,402,337, issued Aug. 2, 2022, entitled VIDEO PIPE INSPECTION SYSTEMS WITH VIDEO INTEGRATED WITH ADDITIONAL SENSOR DATA; U.S. Pat. No. 11,418,761, issued Aug. 16, 2022, entitled INSPECTION CAMERA DEVICES AND METHODS WITH SELECTIVELY ILLUMINATED MULTISENSOR IMAGING; U.S. Pat. No. 11,448,600, issued Sep. 20, 2022, entitled MULTI-CAMERA PIPE INSPECTION APPARATUS, SYSTEMS, AND METHODS; U.S. patent application Ser. No. 17/993,784, filed Nov. 23, 2022, entitled VIDEO PIPE INSPECTION SYSTEMS; U.S. Pat. No. 11,528,401, issued Dec. 13, 2022, entitled PIPE INSPECTION SYSTEMS WITH SELF-GROUNDING PORTABLE CAMERA CONTROLLERS; U.S. patent application Ser. No. 18/091,079, filed Dec. 29, 2022, entitled VIDEO INSPECTION SYSTEMS WITH WIRELESS ENABLED DRUM; U.S. patent application Ser. No. 18/148,850, filed Dec. 30, 2022, entitled SPRING ASSEMBLIES WITH VARIABLE FLEXIBILITY FOR USE WITH PUSH-CABLES AND PIPEINSPECTION SYSTEMS; U.S. Pat. No. 11,550,214, issued Jan. 10, 2023, entitled SPRING ASSEMBLIES WITH VARIABLE FLEXIBLE FOR USE WITH PUSH-CABLES AND PIPE INSPECTION SYSTEMS; U.S. Pat. No. 11,558,537, issued Jan. 17, 2023, entitled VIDEO INSPECTION SYSTEM WITH WIRELESS ENABLED CABLE STORAGE DRUM; U.S. patent application Ser. No. 18/121,547, filed Mar. 14, 2023, entitled DOCKABLE CAMERA REEL AND CAMERA CONTROL UNIT (CCU) SYSTEM; U.S. patent application Ser. No. 18/121,562, filed Mar. 14, 2023, entitled PIPE INSPECTION AND CLEANING APPARATUS AND SYSTEMS; U.S. Provisional Patent Application 63/492,473, filed Mar. 27, 2023, entitled VIDEO INSPECTION AND CAMERA HEAD TRACKING SYSTEMS AND METHODS; U.S. Pat. No. 11,614,412, issued Mar. 28, 2023, entitled PIPE INSPECTION SYSTEMS WITH JETTER PUSH-CABLE; U.S. Pat. No. 11,614,613, issued Mar. 28, 2023, entitled DOCKABLE CAMERA REEL AND CCU SYSTEM; U.S. patent application Ser. No. 18/130,341, filed Apr. 3, 2023, entitled VIDEO PUSH-CABLES FOR PIPE INSPECTION SYSTEMS; U.S. Pat. No. 11,621,099, issued Apr. 4, 2023, entitled COAXIAL VIDEO PUSH-CABLES FOR USE IN INSPECTION SYSTEMS; U.S. patent application Ser. No. 18/135,661, filed Apr. 17, 2023, entitled VIDEO PIPE INSPECTION SYSTEMS AND METHODS WITH SENSOR DATA; U.S. patent application Ser. No. 18/140,488, filed Apr. 27, 2023, entitled INTEGRATED FLEX-SHAFT CAMERA SYSTEM; U.S. Pat. No. 11,639,990, issued May 2, 2023, entitled VIDEO PIPE INSPECTION SYSTEMS WITH VIDEO INTEGRATED WITH ADDITIONAL SENSOR DATA; U.S. Pat. No. 11,649,917, issued May 16, 2023, entitled INTEGRATED FLEX-SHAFT CAMERA SYSTEM WITH HAND CONTROL; U.S. patent application Ser. No. 18/203,029, filed May 29, 2023, entitled SELF-LEVELING INSPECTION SYSTEMS AND METHODS; U.S. Pat. No. 11,665,321, issued May 30, 2023, entitled PIPE INSPECTION SYSTEM WITH REPLACEABLE CABLE STORAGE DRUM; U.S. patent application Ser. No. 18/207,898, filed Jun. 9, 2023, entitled SONDE DEVICES WITH A SECTIONAL CORE; U.S. Pat. No. 11,674,906, issued Jun. 13, 2023, entitled SELF-LEVELING INSPECTION SYSTEMS AND METHODS; U.S. Provisional Patent Application 63/510,014, filed Jun. 23, 2023, entitled INNER DRUM MODULE WITH PUSH-CABLE INTERFACE FOR PIPE INSPECTION; U.S. Pat. No. 11,709,289, issued Jul. 25, 2023, entitled SONDE DEVICES WITH A SECTIONAL FERRITE CORE; U.S. patent application Ser. No. 18/365,225, filed Aug. 3, 2023, entitled SYSTEMS AND METHODS FOR INSPECTION ANIMATION; U.S. Pat. No. 11,719,376, issued Aug. 8, 2023, entitled DOCKABLE TRIPODAL CAMERA CONTROL UNIT; U.S. patent application Ser. No. 18/490,763, filed Oct. 20, 2023, entitled LINKED CABLE-HANDLING AND CABLE-STORAGE DRUM DEVICES AND SYSTEMS FOR THE COORDINATED MOOVEMENT OF A PUSH-CABLE; U.S. Provisional Patent Application 63/599,890, filed Nov. 16, 2023, entitled VIDEO INSPECTION AND CAMERA HEAD TRACKING SYSTEMS AND METHODS; U.S. patent application Ser. No. 18/528,773, filed Dec. 4, 2023, entitled PIPE INSPECTION SYSTEM CAMERA HEAD; U.S. Pat. No. 11,842,474, issued Dec. 12, 2023, entitled PIPE INSPECTION SYSTEM CAMERA HEADS; U.S. patent application Ser. No. 18/539,265, filed Dec. 14, 2023, entitled INTEGRAL DUAL CLEANER DRUM SYSTEMS AND METHODS; U.S. patent application Ser. No. 18/539,268, filed Dec. 14, 2023, entitled HIGH FREQUENCY AC-POWERED DRAIN CLEANING AND INSPECTION APPARATUS AND METHODS; U.S. Pat. No. 11,846,095, issued Dec. 19, 2023, entitled HIGH FREQUENCY AC-POWERED DRAIN CLEANING AND INSPECTION APPARATUS & METHODS; U.S. Pat. No. 11,859,755, issued Jan. 2, 2024, entitled INTEGRAL DUAL CLEANER CAMERA DRUM SYSTEMS AND METHODS; U.S. patent application Ser. No. 18/412,452, filed Jan. 12, 2024, entitled MULTI-CAMERA APPARATUS FOR WIDE ANGLE PIPE INTERNAL INSPECTION; U.S. patent application Ser. No. 18/414,785, filed Jan. 17, 2024, entitled SONDE DEVICES; U.S. Pat. No. 11,879,852, issued Jan. 23, 2024, entitled MULTI-CAMERA APPARATUS FOR WIDE ANGLE PIPE INTERNAL INSPECTION; U.S. Pat. No. 11,880,005, issued Jan. 23, 2024, entitled SONDE DEVICES INCLUDING A SECTIONAL FERRITE CORE STRUCTURE; U.S. Provisional Patent Application 63/625,259, filed Jan. 25, 2024, entitled ACCESSIBLE DRUM-REEL FRAME FOR PIPE INSPECTION CAMERA SYSTEM; U.S. Provisional Patent Application 63/552,522, filed Feb. 12, 2024, entitled ACCESSIBLE DRUM-REEL FRAME FOR PIPE INSPECTION CAMERA SYSTEM; U.S. Pat. No. 11,909,150, issued Feb. 20, 2024, entitled ROBUST IMPEDANCE CONTROLLED SLIP RINGS; U.S. patent application Ser. No. 18/611,449, issued Mar. 20, 2024, entitled VIDEO INSPECTION AND CAMERA HEAD TRACKING SYSTEMS AND METHODS; U.S. Pat. No. 11,962,943, issued Apr. 16, 2024, entitled INSPECTION CAMERA DEVICES AND METHODS; U.S. Pat. No. 11,988,951, issued May 21, 2024, entitled MULTI-DIELECTRIC COAXIAL PUSH-CABLES AND ASSOCIATED APPARATUS; U.S. patent application Ser. No. 18/717,942, filed Jun. 19, 2024, entitled INNER DRUM MODULE WITH PUSH-CABLE INTERFACE FOR PIPE INSPECTION; U.S. Provisional Patent Application 63/674,749, filed July 23, 2024, entitled PIPE MAPPING FOR FEATURE AND ASSET RECOGNITION USING ARTIFICIAL INTELLIGENCE; and U.S. Provisional Patent Application 63/719,026, filed Nov. 11, 2024, entitled PUSH-CABLE WITH OFFSET JACKET EXTRUSION. The content of each of the above-described patents and applications is incorporated by reference herein in its entirety. The above-described patent applications and patents may be referred to herein collectively as the “incorporated applications.”. The content of each of the above-described patents and applications is incorporated by reference herein in its entirety. The above applications may be collectively denoted herein as the “co-assigned applications” or “incorporated applications.”

The following exemplary embodiments are provided for the purpose of illustrating examples of various aspects, details, and functions of apparatus and systems; however, the described embodiments are not intended to be in any way limiting. It will be apparent to one of ordinary skill in the art that various aspects may be implemented in other embodiments within the spirit and scope of the present disclosure.

It is noted that as used herein, the term, “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Terminology

As used herein, the term “letterboxing” may refer to the process by which “empty space” may appear on an inspection video or image due to a difference in the shape and orientation of the field of view captured by the imaging sensors and that shown on an associated display. For instance, as used in the film industry and other video processing, often a difference in aspect ratios between the camera and a display may result in a video or film to contain blocks void of video/images on the top and bottom of video or images on the display to preserve the aspect ratio of the images/video generated by the camera. Because of the rectangular framing of images and video that may be rotated in digital self-leveling camera systems to achieve an upright, earth normal orientation, the “letterboxing” herein may generally occur in corners or lobes as such rotations occur. It should further be noted, that such “empty space,” as related to letterboxing, may include the addition black or other pixels to frame the field of view captured by the image sensors for areas void of inspection imagery.

The term “magnification” or “magnify” as used herein may refer to the enlarging of a portion of the field of view captured by imaging sensors generally to fill or substantially fill a particular display avoiding the empty spaces generated via letterboxing. Such magnification may generally be digital but may also be achieved via physical optics or a combination of the two.

The term “image” may refer to a still image or video from an inspection camera.

### Example Embodiments

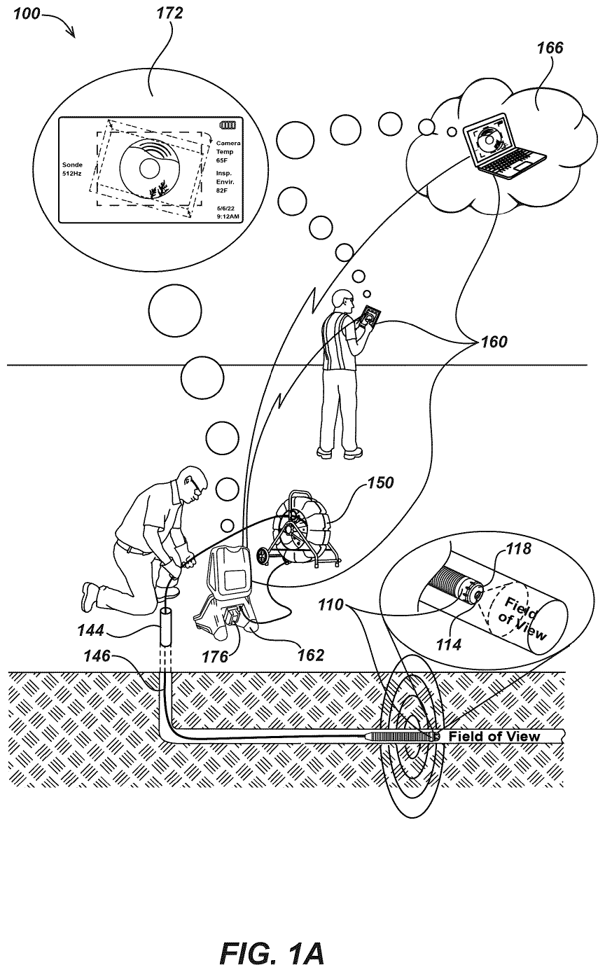

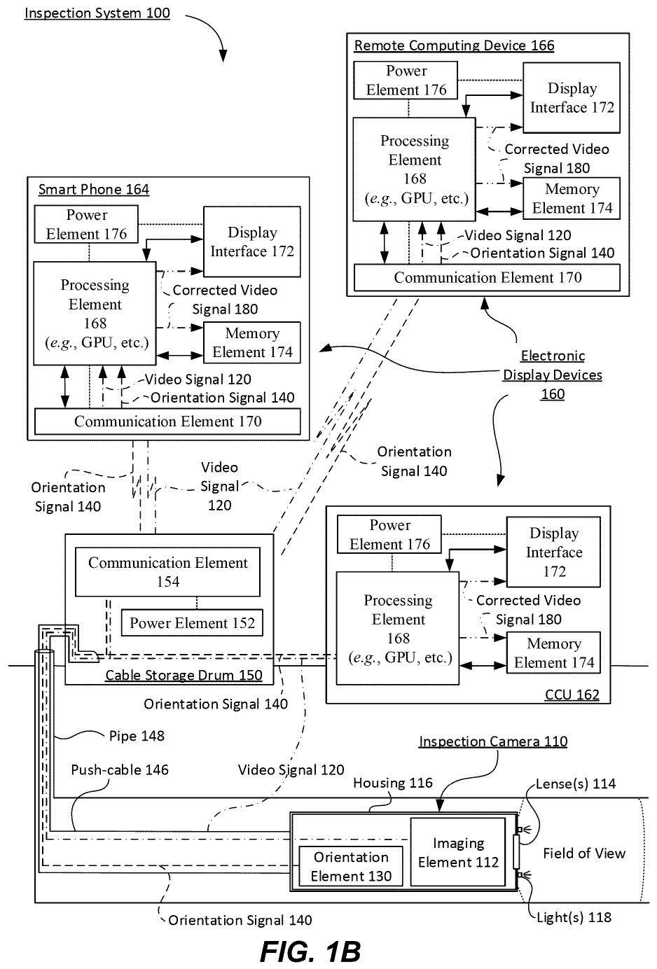

Referring to FIGS. 1A and 1B, an inspection system 100 in keeping with the present disclosure is illustrated which may include automatic magnification to compensate for letterboxing of inspection images caused during self-leveling rotations. The inspection system 100 may include an inspection camera 110 having an imaging element 112 (FIG. 1B) that includes one or more imaging sensors positioned behind one or more lenses 114 and disposed in a housing 116 in generating a video signal 120. It should be noted, one or more lights 118 may illuminate the field of view captured by the inspection camera 110 in generating the video signal 120 (FIG. 1B). The inspection camera 110 may be or share aspects with the cameras disclosed in U.S. Pat. No. 6,831,679, entitled VIDEO CAMERA HEAD WITH THERMAL FEEDBACK LIGHTING CONTROL issued Dec. 14, 2004; U.S. Pat. No. 8,587,648, entitled SELF-LEVELING CAMERA HEAD, issued Nov. 9, 2013; U.S. Pat. No. 9,066,446, entitled THERMAL EXTRACTION ARCHITECTURE FOR CAMERA HEAD, INSPECTION SYSTEMS, AND OTHER DEVICES AND SYSTEMS issued Jun. 23, 2015; U.S. Pat. No. 9,277,105, entitled SELF-LEVELING CAMERA HEADS, issued Mar. 1, 2016; U.S. Pat. No. 9,824,433 entitled PIPE INSPECTION SYSTEM CAMERA HEADS, issued on Nov. 21, 2017; U.S. Pat. No. 9,835,564, entitled MULTI-CAMERA PIPE INSPECTION APPARATUS, SYSTEM, AND METHODS, issued Dec. 5, 2017; U.S. Pat. No. 10,288,997, entitled ROTATING CONTACT ASSEMBLIES FOR SELF-LEVELING CAMERA HEADS, issued May 14, 2019; U.S. Pat. No. 10,715,703, entitled SELF-LEVELING CAMERA HEADS, issued Jul. 14, 2020; U.S. Pat. No. 10,848,655, entitled HEAT EXTRACTION ARCHITECTURE FOR COMPACT VIDEO CAMERA HEADS, issued Nov. 24, 2020; U.S. Pat. No. 11,209,115, entitled PIPE INSPECTION AND/OR MAPPING CAMERA HEADS, SYSTEMS, AND METHODS, issued Dec. 28, 2021; and/or other disclosed in the incorporated patents and applications. The content of each of these applications is incorporated by reference herein in its entirety. The inspection camera 100 may further include an orientation element 130 (FIG. 1B) having one or more orientation sensors (e.g., accelerometers, gyroscopic sensors, or other orientation determining sensors and mechanisms) in generating an orientation signal 140 (FIG. 1B) describing the orientation of an inspection image representing the field of view captured by the inspection camera 110 in the video signal 120 (FIG. 1B) relative to upright, earth normal orientation.

The inspection camera 110 may be disposed on the end of a push-cable 146 dispensed from a cable storage drum 150 allowing the inspection camera 110 to be moved through a pipe 148 or other inspection environment. The push-cable 146 may be configured to communicate the video signals 120 (FIG. 1B) and orientation signals 140 (FIG. 1B) to one or more electronic display devices 160 such as, but not limited to, a camera control unit (CCU) 162, smart phone 164, remote computing device 166, or the like. The push-cable 146 may be or share aspects with those disclosed in U.S. Pat. No. 5,939,679, entitled VIDEO PUSH CABLE, issued Aug. 17, 1999; U.S. Pat. No. 9,448,376, entitled HIGH BANDWIDTH PUSH-CABLES FOR VIDEO INSPECTION SYSTEMS, issued Sep. 20, 2016; U.S. Pat. No. 9,468,954, entitled PIPE INSPECTION SYSTEM INCLUDING JETTER PUSH-CABLE, issued Oct. 18, 2016; U.S. Pat. No. 10,764,541, entitled COAXIAL VIDEO PUSH-CABLES FOR USE IN INSPECTION SYSTEMS, issued Sep. 1, 2020; and/or other disclosed in the incorporated patents and applications. The content of each of these applications is incorporated by reference herein in its entirety.

Referring to FIG. 1B, the cable storage drum 150 may include a communication element 152 (e.g., Wi-Fi, Bluetooth, or the like) to wireless communicate the video signals 120 and orientation signals 140 to the smart phone 164, the remote computing device 166, or other or other electronic display devices. Uncorrected video may also be output with metadata describing the orientation instead of using an orientation signal 140. In such cable-storage drum embodiments as the cable storage drum 150, a power element 154 may provide electrical power to the communication element 152 and/or other powered element that may be on or coupled with the cable storage drum 150. The power element 154 may be or include one or more batteries, grid tied power, or the like. In some such embodiments the power element 154 may be or include that may provide electrical power to the communication element 152. The one or more batteries of power element 154 may be or share aspects with those disclosed in U.S. Pat. No. 10,090,498, entitled MODULAR BATTERY PACK APPARATUS, SYSTEMS, AND METHODS INCLUDING VIRAL DATA AND/OR CODE TRANSFER, issued Oct. 2, 2018; U.S. Pat. No. 11,171,369, entitled MODULAR BATTERY PACK APPARATUS, SYSTEMS, AND METHODS, issued Nov. 9, 2021; U.S. Pat. No. 11,894,707, entitled RECHARGEABLE BATTERY PACK ONBOARD CHARGE STATE INDICATION METHOD AND APPARATUS, issued Feb. 6, 2024; and/or other disclosed in the incorporated patents and applications. The content of each of these applications is incorporated by reference herein in its entirety. The communication element 152 may be or share aspects with the devices disclosed in United States Patent Application Ser. No. 17/528,956, entitled VIDEO INSPECTION SYSTEM APPARATUS AND RELAY MODULES AND CONNECTION PORTS, filed Nov. 17, 2021 and/or others disclosed in the incorporated patents and applications. The content of each of these applications is incorporated by reference herein in its entirety. Further, the cable storage drum 150 may be or share aspects with those disclosed in U.S. Pat. No. 6,958,767, entitled VIDEO PIPE INSPECTION SYSTEM EMPLOYING NON-ROTATING CABLE STORAGE DRUM, issued Oct. 25, 2005; U.S. Pat. No. 8,908,027, entitled ASYMMETRIC DRAG FORCE BEARING FOR USE IN PUSH-CABLE STORAGE DRUM, issued Dec. 9, 2014; U.S. Pat. No. 10,009,582, entitled PIPE INSPECTION SYSTEM WITH REPLACEABLE CABLE STORAGE DRUM, issued Jun. 26, 2018; U.S. Pat. No. 10,084,945, entitled CABLE STORAGE DRUM WITH MOVEABLE CCU DOCKING APPARATUS, issued Sep. 25, 2018; U.S. patent application Ser. No. 17/110,273, entitled INTEGRAL DUAL CLEANER CAMERA DRUM SYSTEMS AND METHODS, filed Dec. 2, 2020; U.S. patent application Ser. No. 17/815,387, entitled INWARD SLOPED DRUM FACE FOR DRUM INSPECTION CAMERA SYSTEMS, filed Jul. 27, 2022; U.S. Pat. No. 11,558,537, entitled VIDEO INSPECTION SYSTEM WITH WIRELESS CABLE STORAGE DRUM, issued Jan. 17, 2023; and/or others disclosed in the incorporated patents and applications. The content of each of these applications is incorporated by reference herein in its entirety. The CCU 162 may be or share aspects with those disclosed in U.S. Pat. No. 10,084,945, entitled CABLE STORAGE DRUM WITH MOVEABLE CCU DOCKING APPARATUS, issued Sep. 25, 2018; U.S. Pat. No. 11,614,613, issued Mar. 28, 2023, entitled DOCKABLE CAMERA REEL AND CCU SYSTEM; and/or other disclosed in the incorporated patents and applications. The content of each of these applications is incorporated by reference herein in its entirety.

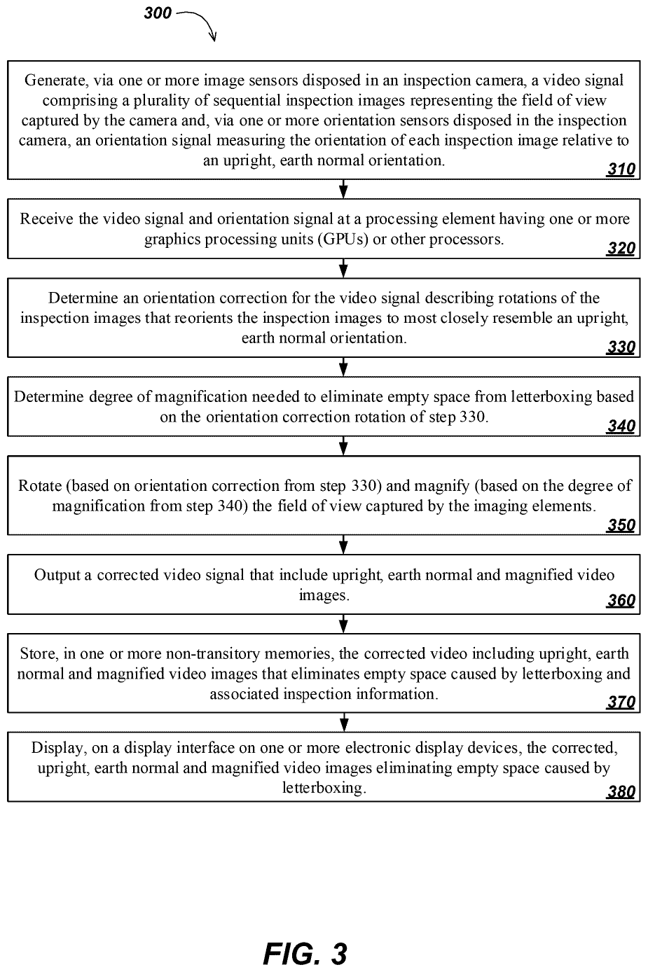

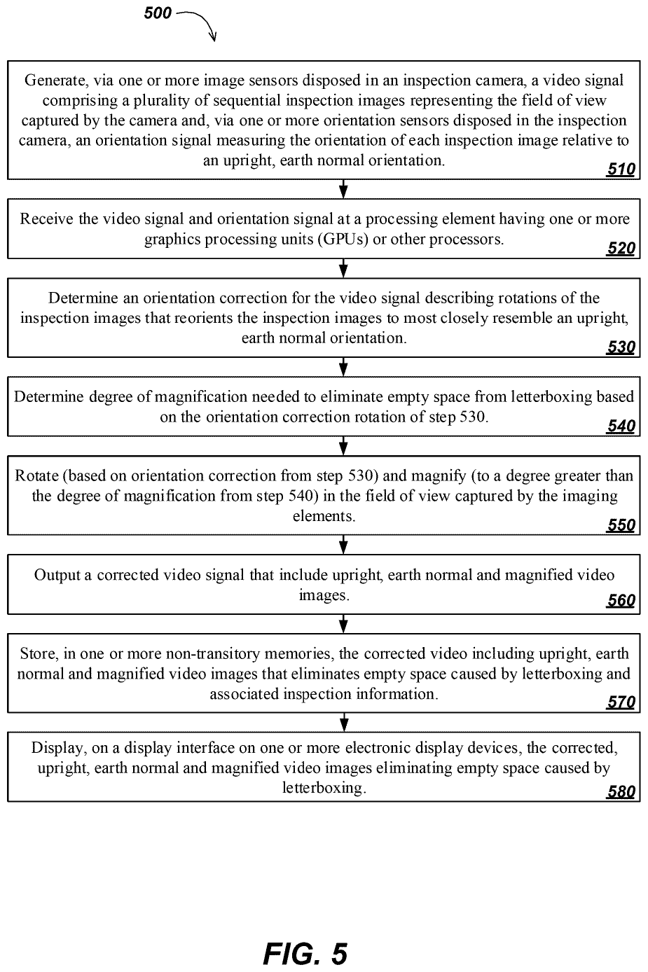

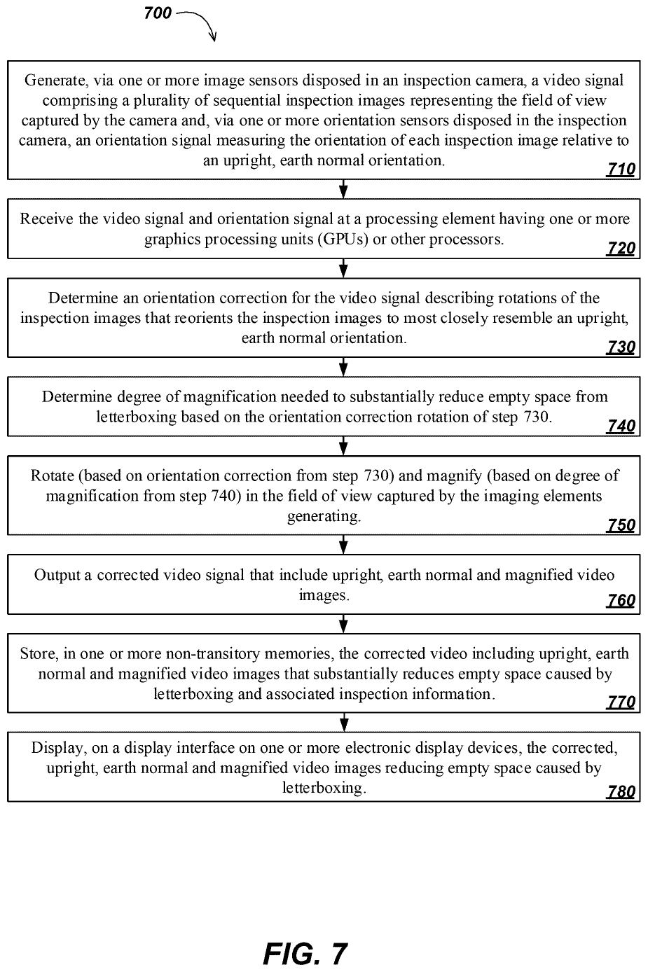

Still referring to FIG. 1B, each of the electronic display devices 160 (e.g., the CCU 162, smart phone 164 remote computing device 166, and the like) may include a processing element 168 having one or more processors receiving the video signals 120 and orientation signals 140 from the inspection camera 110 via a wired connection or the communication element 152 of the cable storage drum 150 (e.g., communicating with another communication element 170 disposed in the smart phone 164 or remote computing device 166 or the like). The processing element 168 may be configured to determine and output a corrected video signal 180 having a corrected, upright, earth normal oriented video that includes magnification on the field of view captured by image sensors of the imaging element 112 to eliminate or substantially reduce empty space caused by letterboxing (e.g., using the method 300 of FIG. 3, the method 500 of FIG. 5, or the method 700 of FIG. 7). Reorienting of inspection image to an upright, earth normal orientation may utilize the methods and devices and disclosed in U.S. patent application Ser. No. 18/365,225, filed Aug. 3, 2023, entitled SYSTEMS AND METHODS FOR INSPECTION ANIMATION and/or other disclosed in the incorporated patents and applications and/or other known methods for reorienting video images. In some embodiments the processing element 170 (FIG. 1B) may be or include one or more GPUs or the like processors. Further, in some embodiments, such a processing element as the processing element 170 may be disposed in a different computing device and the processing of data may fully or partially be carried out in the different computing device (e.g., the CCU 162, the smart phone 164, or the remote computing device 166 which may be a cloud computing device or the like). The output corrected video signal 180 may be communicated to a display interface 172 for displaying the upright, earth normalized and zoomed in inspection and optional additional data relating to the inspection and/or inspection system devices. Each of the display devices 160 (e.g., the CCU 162, smart phone 164, remote computing device 166, and others that may not be illustrated) may also include a memory element 174 having one or more non-transitory memories in storing corrected video signals including magnified video images based on the rotation of the corrected, upright, earth normal video images to eliminate or substantially reduce empty space caused by letterboxing and optional additional data relating to the inspection and/or inspection system devices.

The inspection images generated by a camera in an inspection system in keeping with the present disclosure, such as the system 100 of FIGS. 1A and 1B, may generate one or more orientation correction to reorient inspection images to best realign with the upright, earth normal orientation. In such systems in keeping with the present invention, a degree of magnification may be determined to eliminate empty space caused by letterboxing during such rotations.

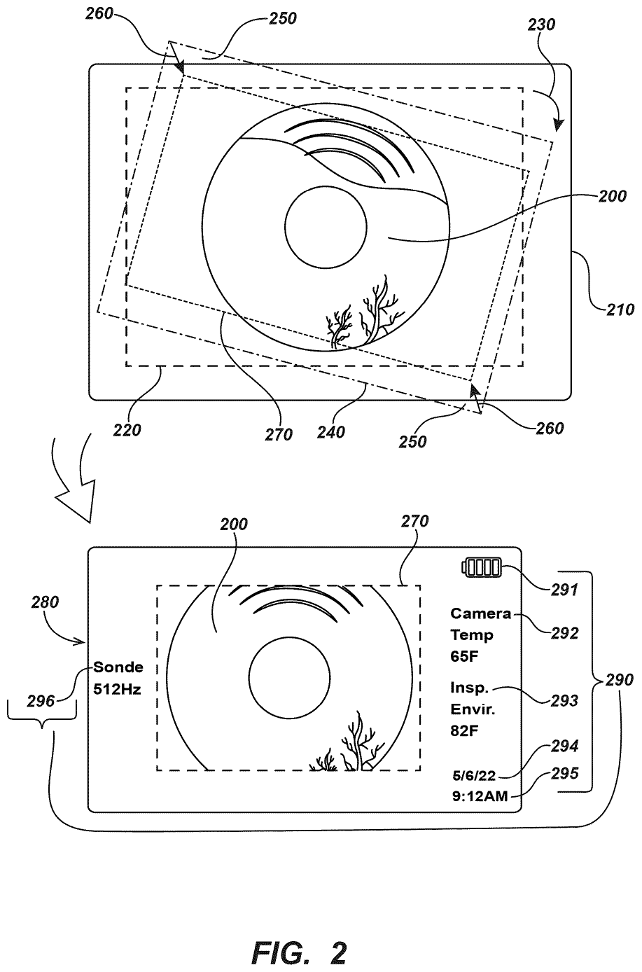

Turning to FIG. 2, an illustration of a self-leveling rotation and associated magnification to eliminate empty space caused by letterboxing is provided. As illustrated, an image 200 from inside a pipe or other cavity may be captured in an imaging element's field of view 210. Based on a difference in aspect ratios of the display interface and imaging sensors, a pre-rotation display area 220, which is a portion of the imaging element's field of view 210, is shown. As the orientation element (e.g., the orientation element 130 of FIG. 1B) determines that need for a self-leveling rotation correction 230, the pre-rotation display area 220 may rotate to a post-rotation display area 240 position. As illustrated, a number of corners 250 may fall outside the area captured in the imaging element's field of view 210. In order to prevent letterboxing, a degree of magnification 260 that eliminates the corners 250 may be determined resulting in an upright, earth normal and magnified inspection image area 270. It should be noted the “corrected signals” or “corrected video signals” as disclosed herein may include images/video from an upright, earth normal and magnified inspection image area such as the upright, earth normal and magnified inspection image area 270 that, upon magnification, may fill the display area of a display interface 280.

Still referring to FIG. 2, the portion of the image 200 captured in the upright, earth normal and magnified inspection image area 270 of a corrected video signal may be shown on the display interface 280 (e.g., the CCU 162, smart phone 164, or remote computing device 166 of FIGS. 1A and 1B or the like). The display interface 280 may optionally include non-rotating and non-magnified additional information 290 independent of the inspection images of the corrected video signal. For instance, the additional information 290 may include but is not limited to a battery status indicator 291 of the electronic display device or other system devices, an internal inspection camera temperature status 292, an external inspection environment temperature 293, a date of inspection 294, a time of inspection 295, a Sonde indicator 296 to notate one or more pipe Sondes associated with the inspection system, and/or the like.

Turning to FIG. 3, a method 300 is disclosed for displaying inspection images from digital self-leveling inspection system that eliminates empty space caused from letterboxing during self-leveling rotations. In a step 310 the method may include generating, via one or more image sensors disposed in an inspection camera, a video signal comprising a plurality of sequential inspection images representing the field of view captured by the camera and, via one or more orientation sensors disposed in the inspection camera, an orientation signal measuring the orientation of each inspection image relative to an upright, earth normal orientation. In a step 320 the method 300 may include receiving the video signal and orientation signal at a processing element having one or more graphics processing units (GPUs) or other processors. In a step 330 the method 300 may include determining an orientation correction for the video signal describing rotations of the inspection images that reorients the inspection images to most closely resemble an upright, earth normal orientation. Orientation corrections to an upright, earth normal orientation of step 330 may be determined via the methods and devices and disclosed in U.S. patent application Ser. No. 18/365,225, filed Aug. 3, 2023, entitled SYSTEMS AND METHODS FOR INSPECTION ANIMATION and/or other disclosed in the incorporated patents and applications and/or other known methods for reorienting video images. In a step 340 the method 300 may include determining the degree of magnification needed to eliminate empty space from letterboxing based on the orientation correction rotation of step 330. In a step 350 the method 300 may include rotating (based on orientation correction from step 330) and magnifying (based on the degree of magnification from step 340) the field of view captured by the imaging element. In a step 360 the method 300 may include outputting a corrected video signal that include upright, earth normal and magnified video images. In a step 370 the method 300 may include storing, in one or more non-transitory memories, the corrected video including upright, earth normal and magnified video images that eliminates empty space caused by letterboxing and associated inspection information. In a step 380 the method 300 may include displaying, on a display interface on one or more electronic display devices, the corrected, upright, earth normal and magnified video images eliminating empty space caused by letterboxing. It should be noted, in some embodiments, the method 300 may be carried out in real-time or near real-time. In other embodiments, the method 300 may be carried out in post processing.

In keeping with the present invention, the degree of magnification may be greater than needed to eliminate empty space caused by letterboxing during self-leveling rotations.

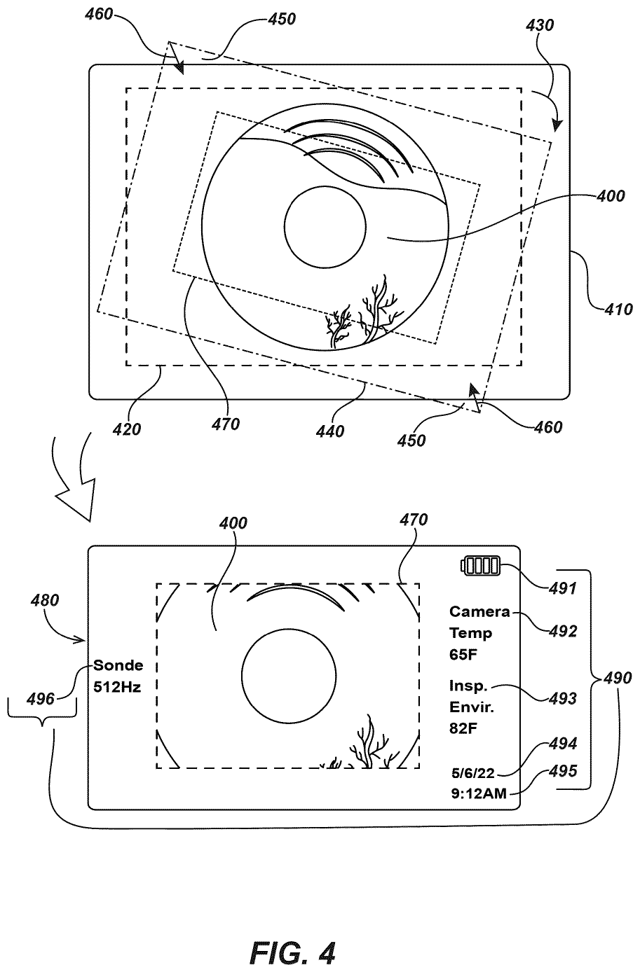

Turning to FIG. 4, an illustration of a self-leveling rotation and associated magnification greater than that needed to eliminate the empty space caused by letterboxing is provided. As illustrated, an image 400 from inside a pipe or other cavity may be captured in an imaging element's field of view 410. Based on a difference in aspect ratios of the display interface and imaging sensors, a pre-rotation display area 420, which is a portion of the imaging element's field of view 410, is shown. As the orientation element (e.g., the orientation element 130 of FIG. 1B) determines that need for a self-leveling rotation correction 430, the pre-rotation display area 420 may rotate to a post-rotation display area 440 position. As illustrated, a number of corners 450 may fall outside the area captured in the imaging element's field of view 410. In order to prevent letterboxing, a degree of magnification 460 that is greater than that needed to eliminate the corners 450 may be determined resulting in an upright, earth normal and magnified inspection image area 470. It should be noted the “corrected signals” or “corrected video signals” as disclosed herein may include images/video from an upright, earth normal and magnified inspection image area such as the upright, earth normal and magnified inspection image area 470 that, upon magnification, may fill the display area of a display interface 480.

Still referring to FIG. 4, the portion of the image 400 captured in the upright, earth normal and magnified inspection image area 470 of a corrected video signal may be shown on the display interface 480 (e.g., the CCU 162, smart phone 164, or remote computing device 166 of FIGS. 1A and 1B or the like). The display interface 480 may optionally include non-rotating and non-magnified additional information 490 independent of the inspection images of the corrected video signal. For instance, the additional information 490 may include but is not limited to a battery status indicator 491 of the electronic display device or other system devices, an internal inspection camera temperature status 492, an external inspection environment temperature 493, a date of inspection 494, a time of inspection 495, a Sonde indicator 496 to notate one or more pipe Sondes associated with the inspection system, and/or the like.

Turning to FIG. 5, a method 500 is disclosed for displaying inspection images from digital self-leveling inspection system that eliminates empty space caused from letterboxing during self-leveling rotations using greater than necessary magnification. In a step 510 the method may include generating, via one or more image sensors disposed in an inspection camera, a video signal comprising a plurality of sequential inspection images representing the field of view captured by the camera and, via one or more orientation sensors disposed in the inspection camera, an orientation signal measuring the orientation of each inspection image relative to an upright, earth normal orientation. In a step 520 the method 500 may include receiving the video signal and orientation signal at a processing element having one or more graphics processing units (GPUs) or other processors. In a step 530 the method 500 may include determining an orientation correction for the video signal describing rotations of the inspection images that reorients the inspection images to most closely resemble an upright, earth normal orientation. Orientation corrections to an upright, earth normal orientation of step 530 may be determined via the methods and devices and disclosed in U.S. patent application Ser. No. 18/365,225, filed Aug. 3, 2023, entitled SYSTEMS AND METHODS FOR INSPECTION ANIMATION and/or other disclosed in the incorporated patents and applications and/or other known methods for reorienting video images. In a step 540 the method 500 may include determining the degree of magnification needed to eliminate empty space from letterboxing based on the orientation correction rotation of step 530. In a step 550 the method 500 may include rotating (based on orientation correction from step 530) and magnifying (to a degree greater than the degree of magnification from step 540) the field of view captured by the imaging element. In a step 560 the method 500 may include outputting a corrected video signal that include upright, earth normal and magnified video images. In a step 570 the method 500 may include storing, in one or more non-transitory memories, the corrected video including upright, earth normal and magnified video images that eliminates empty space caused by letterboxing and associated inspection information. In a step 580 the method 500 may include displaying, on a display interface on one or more electronic display devices, the corrected, upright, earth normal and magnified video images eliminating empty space caused by letterboxing. It should be noted, in some embodiments, the method 500 may be carried out in real-time or near real-time. In other embodiments, the method 500 may be carried out in post processing.

In further embodiments keeping with the present invention, the degree of magnification may substantially but not fully eliminate empty space caused by letterboxing during self-leveling rotations.

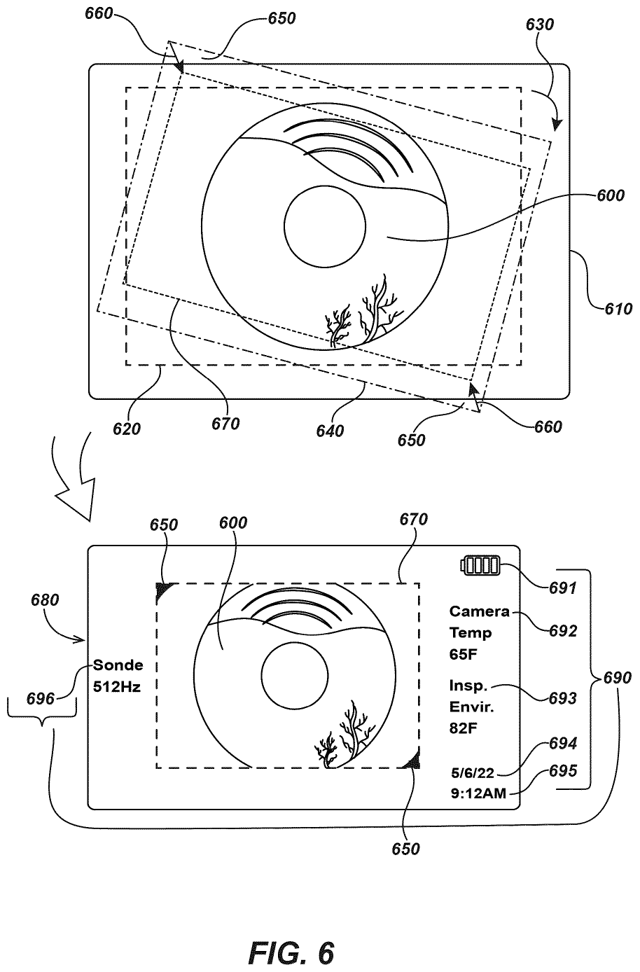

Turning to FIG. 6, an illustration of a self-leveling rotation and associated magnification to substantially reduce empty space caused by letterboxing is provided. As illustrated, an image 600 from inside a pipe or other cavity may be captured in an imaging element's field of view 610. Based on a difference in aspect ratios of the display interface and imaging sensors, a pre-rotation display area 620, which is a portion of the imaging element's field of view 610, is shown. As the orientation element (e.g., the orientation element 130 of FIG. 1B) determines that need for a self-leveling rotation correction 630, the pre-rotation display area 620 may rotate to a post-rotation display area 640 position. As illustrated, a number of corners 650 may fall outside the area captured in the imaging element's field of view 610. In order to prevent letterboxing, a degree of magnification 660 that substantially reduces but does not fully eliminate the corners 650 may be determined resulting in an upright, earth normal and magnified inspection image area 670. It should be noted the “corrected signals” or “corrected video signals” as disclosed herein may include images/video from an upright, earth normal and magnified inspection image area such as the upright, earth normal and magnified inspection image area 670 that, upon magnification, may fill the display area of a display interface 680.

Still referring to FIG. 6, the portion of the image 600 captured in the upright, earth normal and magnified inspection image area 670 of a corrected video signal may be shown on a display interface 680 (e.g., the CCU 162, smart phone 164, or remote computing device 166 of FIGS. 1A and 1B or the like). The empty space from letterboxing generated during orientation correction rotations may be substantially reduce and not completely eliminated in some system embodiments. As such, the empty space in the corners 650 may be filled with black or other pixels when the upright, earth normal and magnified inspection image area 670 of a corrected video signal is shown on the display interface 680. The display interface 680 may optionally include non-rotating and non-magnified additional information 690 independent of the inspection images of the corrected video signal. For instance, the additional information 690 may include but is not limited to a battery status indicator 691 of the electronic display device or other system devices, an internal inspection camera temperature status 692, an external inspection environment temperature 693, a date of inspection 694, a time of inspection 695, a Sonde indicator 696 to notate one or more pipe Sondes associated with the inspection system, and/or the like.

Turning to FIG. 7, a method 700 is disclosed for displaying inspection images from digital self-leveling inspection system that substantially reduces but does not eliminate empty space caused from letterboxing during self-leveling rotations. In a step 710 the method may include generating, via one or more image sensors disposed in an inspection camera, a video signal comprising a plurality of sequential inspection images representing the field of view captured by the camera and, via one or more orientation sensors disposed in the inspection camera, an orientation signal measuring the orientation of each inspection image relative to an upright, earth normal orientation. In a step 720 the method 700 may include receiving the video signal and orientation signal at a processing element having one or more graphics processing units (GPUs) or other processors. In a step 730 the method 700 may include determining an orientation correction for the video signal describing rotations of the inspection images that reorients the inspection images to most closely resemble an upright, earth normal orientation. Orientation corrections to an upright, earth normal orientation of step 730 may be determined via the methods and devices and disclosed in U.S. patent application Ser. No. 18/365,225, filed Aug. 3, 2023, entitled SYSTEMS AND METHODS FOR INSPECTION ANIMATION and/or other disclosed in the incorporated patents and applications and/or other known methods for reorienting video images. In a step 740 the method 700 may include determining the degree of magnification needed to substantially reduce empty space from letterboxing based on the orientation correction rotation of step 730. For instance, the substantial reduction may be to a degree that is not noticeable or bothersome to a viewer or the like. In a step 750 the method 700 may include rotating (based on orientation correction from step 730) and magnifying (based on the degree of magnification from step 740) the field of view captured by the imaging element. In a step 760 the method 700 may include outputting a corrected video signal that include upright, earth normal and magnified video images. In a step 770 the method 700 may include storing, in one or more non-transitory memories, the corrected video including upright, earth normal and magnified video images that substantially reduces empty space caused by letterboxing and associated inspection information. In a step 780 the method 700 may include displaying, on a display interface on one or more electronic display devices, the corrected, upright, earth normal and magnified video images substantially reducing empty space caused by letterboxing. It should be noted, in some embodiments, the method 700 may be carried out in real-time or near real-time. In other embodiments, the method 700 may be carried out in post processing.

In some configurations, the apparatus or systems described herein may include means for implementing features or providing functions described herein. In one aspect, the aforementioned means may be a module including a processor or processors, associated memory and/or other electronics in which embodiments of the invention reside, such as to implement image and/or video signal processing, switching, transmission, or other functions to process and/or condition camera outputs, control lighting elements, control camera selection, or provide other electronic or optical functions described herein. These may be, for example, modules or apparatus residing in camera assemblies, camera and lighting assemblies, or other assemblies disposed on or within a push-cable or similar apparatus.

Those of skill in the art would understand that information and signals, such as video and/or audio signals or data, control signals, or other signals or data may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, electro-mechanical components, or combinations thereof. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative functions and circuits described in connection with the embodiments disclosed herein with respect to tools, instruments, and other described devices may be implemented or performed in one or more processing elements using elements such as a general or special purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Processing elements may include hardware and/or software/firmware to implement the functions described herein in various combinations.

The previous description of the disclosed embodiments is provided to enable any person skilled in the art to make or use various embodiments. Various modifications to these embodiments will be readily apparent to those skilled in the art, and the generic principles defined herein may be applied to other embodiments without departing from the spirit or scope of the disclosure.

Accordingly, the presently claimed invention is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the scope of the present disclosure is not intended to be limited to only the specific aspects shown herein but should be accorded the widest scope consistent with the embodiments herein and their equivalents.

We claim:

1. A display method for use in digital self-leveling pipe inspection camera systems, comprising:
generating, via one or more image sensors disposed in an inspection camera, a video signal comprising a plurality of sequential inspection images representing a field of view captured by the camera and, via one or more orientation sensors disposed in the inspection camera, an orientation signal measuring the orientation of the inspection images relative to an upright, earth normal orientation in inspection images of the video signal;
receiving the video signal and orientation signal at a processing element having one or more graphics processing units (GPUs) or other processors;
determining an orientation correction for the video signal describing rotations of the inspection images that reorients the images to most closely resemble an upright, earth normal orientation;
magnifying, based on the orientation correction, in on the field of view captured by the image sensor(s) to eliminate empty space caused by letterboxing;
outputting a corrected video signal that includes an upright, earth normal oriented and magnified video to eliminate empty space caused by letterboxing; and
displaying, on a display interface on one or more electronic display devices, the corrected upright and magnified video images from the corrected video signal.

2. The method of claim 1, wherein the degree of magnification exceeds what is needed to eliminate the empty space caused by letterboxing.

3. The method of claim 1, wherein the degree of magnification substantially reduces does but not fully eliminate empty space caused by letterboxing.

4. The method of claim 1, wherein the method is carried out and displayed in real-time or near real-time.

5. The method of claim 1, wherein the corrected video signal that includes the upright, earth normal oriented and magnified video images is stored in one or more non-transitory memories.

6. The method of claim 5, wherein the method is carried out in post-processing in one or more electronic display devices.

7. The method of claim 1, wherein non-rotating and non-magnified additional information may be shown on a display interface during self-leveling of inspection video images independent of the inspection images of the corrected video signal.

8. An inspection system for digital self-leveling of inspection images that includes magnification to eliminate or substantially reduce empty space caused by letterboxing, comprising:
an inspection camera, comprising;
an imaging element having one or more imaging sensors positioned behind one or more lenses and disposed in a housing for generating a video signal;
an orientation element having one or more orientation sensors in generating an orientation signal describing the orientation of the inspection images relative to upright, earth normal orientation;
a processing element having one or more processors receiving video signals and orientation signals from the inspection camera and outputting a corrected video signal having a corrected, upright, earth normal video that includes magnification, based on the rotation of the corrected, upright, earth normal video images, to eliminate or substantially reduce empty space caused by letterboxing;
a memory element having one or more non-transitory memories for storing corrected video signal including magnified video images based on the rotation of the corrected, upright, earth normal video images to at least eliminate or substantially reduce empty space caused by letterboxing; and
a display interface to display the corrected, upright, earth normal and magnified video images of the corrected video signal.

9. The inspection system of claim 8, wherein the processing element includes one or more graphical processor units (GPUs).

10. The inspection system of claim 8, wherein the electronic display device is or includes a camera control unit (CCU) used in pipe inspection systems.

11. The inspection system of claim 8, wherein the electronic display device includes a smart phone, tablet or laptop computer, PC, or other remotely connected computing device.

12. The inspection system of claim 8, wherein the display interface includes additional information that is non-rotating and non-magnified independent from inspection images.
